(19) United States
(12) Patent Application Publication
(10) Pub. No.: US 2020/0334671 A1
(43) Pub. Date: Oct. 22, 2020

(54) ENCRYPTED AND AUTHENTICATED MESSAGE SERVICES

(71) Applicant: Velo Holdings Limited, London (GB)

(72) Inventors: John Terrell DAVIES, London (GB); Andrew WEINSTEIN, Ross, CA (US)

(21) Appl. No.: 16/643,053

(22) PCT Filed: Aug. 30, 2018
(86) PCT No.: PCT/IB18/01101

§ 371 Date: Feb. 28, 2020

Related U.S. Application Data
(60) Provisional application No. 62/552,999, filed on Aug. 31, 2017.

(51) Int. Cl. G06Q 20/38; G06Q 20/06; G06Q 20/40; H04L 9/06

(52) U.S. Cl. CPC G06Q 20/381; G06Q 20/3829; H04L 2209/38; G06Q 20/4016; H04L 9/0637; G06Q 20/065

(57) ABSTRACT

A system manages payments by an entity to its partners (suppliers, service providers, etc.) by providing an intermediary capability to disaggregate and regenerate payment orders using real time inputs from the payee. A single obligation may be split into different payments to different institutions and payment vehicles such as prepaid cards, countries, and currencies. An Al predictive function may reduce foreign currency transfers and their associated costs by recognizing intra-divisional, intracompany and intercompany assets and liabilities to allow in-country net settlements to be made prior to using a foreign currency transfer. When needed, foreign currency transfers may be aggregated to reduce the volume and velocity of those transfers. Tokenization of financial data and accounts may further protect activity between payors, payees, and financial institutions.

### RELATED CASES

This case claims priority to U.S. Provisional patent application 62/552,999 titled, “ENCRYPTED AND AUTHENTICATED MESSAGE SERVICES” filed 31 Aug. 2018, U.S. Provisional patent application 62/582,073 titled, “BLOCKCHAIN SYSTEM” filed 6 Nov. 2018, U.S. Provisional patent application 62/582,076 titled, “LIMITED SCOPE BLOCKCHAIN SYSTEM” filed 6 Nov. 2018, and U.S. Provisional patent application 62/582,081 titled, “PORTABLE BLOCKCHAIN SYSTEM” filed 6 Nov. 2018. The contents of each of these applications is expressly incorporated by reference for all purposes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Financial transfers between institutions, especially international exchanges, often rely on internal or external networks as an intermediary for completing the transfers. Often these transfers use an institution known as SWIFT, the Society for Worldwide Interbank Financial Telecommunication. SWIFT has its roots in the 1970s and had its last major update in 2007 with the adoption of ISO 20022-2. The network supports messages between financial institutions using a standardized system of codes. The codes carry instructions for member institutions to perform funds transfers but does not itself hold accounts for its members or perform clearing or settlement.

The SWIFT system is the backbone of international business and is deeply embedded in the worldwide processing of money movement between member institutions, such as banks. However, because SWIFT does not perform clearing or settlement, there is no guarantee of completion of a financial transaction ordered through SWIFT. Further, the inflexible data structures, anticipation of manual oversight from participating correspondent bank partners, coding and fee structures associated with SWIFT instructions are tailored to relatively high value, low volume transactions.

### SUMMARY

A system of monitors and a core service provide for applicable to any transfers, but optimized for high volume, low value transfers to be executed using, among other systems, the SWIFT network or other similar standards-based payment or messaging system, while providing end-to-end confirmation of payment and documentation for accomplishing settlement. The monitors are placed at data entry, transaction processing, exit, and reconciliation or auditing points amongst the data flow as well as using existing data access available from the SWIFT network itself. The system may include a payee portal that supports end-destination account validation prior to initiation of a transfer as well as allowing requests for payment splits between settlement types, currency preferences and even destination countries, or such functionality available via API that can be rendered in existing payee-facing systems. Among other things, the system may include a transaction/payload processing engine and payor portal that together disaggregate transfers to a payee to multiple destinations for a single payment, including payouts via financial services such as PayPal and the issuance of prepaid cards. The system may make this functionality available via an API that can be rendered in existing payor-facing treasury management, ERP, cash management or similar types of Treasury systems. Using another feature of the services core, obligations may be tracked worldwide for payors with international obligations supporting in-country settlement between accounts, or even for settling in-country obligations between companies such as through a non-bank currency exchange or private currency marketplace amongst sophisticated enterprises. This may potentially lower the volume and velocity of international funds transfers. A reduction in volume and velocity of international funds transfers may correspondingly reduce international transfer fees and currency exchange fees. The system can also be used for secure messaging payloads that are unaccompanied by any funds: for example, a bank may want to transfer trading instructions from hedge fund clients to its prime brokerage desk, to multiple trading desks around the world in order to execute a trade, open a new capital account with a local trading desk in a region, or much more. This messaging functionality provides benefits for all banks working in multiple countries who are servicing clients operating in multiple countries

### BRIEF DESCRIPTION OF THE DRAWINGS

The figures depict a preferred embodiment for purposes of illustration only. One skilled in the art may readily recognize from the following discussion that alternative embodiments of the structures and methods illustrated herein may be employed without departing from the principles described herein.

FIG. 1 is a block diagram of a system implementing encrypted and authenticated message services;

FIG. 2 is a block diagram of a component of the system of FIG. 1;

FIG. 3 is a block diagram of sub-component of the component of FIG. 2; and

FIG. 4 is a block diagram of another sub-component of component of FIG. 2.

### DETAILED DESCRIPTION

Every funds transfer executed in the current banking environment may be carried via some type of electronic message, from clearing of a paper check to transfers via PayPal or Western Union or even internal transfers between departments within a financial institution. These may include private in-house networks, virtual private networks, public networks using end-to-end encryption, and more. Many of these transactions use the SWIFT network, so while the teachings of the current disclosure may apply to each of these networks, the SWIFT network is discussed at length herein due to its prominent status in the current interbank and international funds transactions. The SWIFT network was designed for and continues to be optimized to service high value, low frequency transactions. The use of the SWIFT network for higher volumes of low value transactions exposes problems associated with the unconfirmed nature of SWIFT transactions, the limited and relatively inflexible data structures of the SWIFT network message, the cost of using the SWIFT network relative to the value being moved, and the inability to expose the messaging beyond the physical infrastructure of the banks, which is the premise of its secure nature. Online retail and smartphone micro-purchases for apps and entertainment downloads require settlement with parties beyond SWIFT network members at a scale never imagined in the 1970s, when the system was developed. For example, even several years ago the Apple iTunes store was selling about $70 million a day of content which, depending on price, may represent tens of millions of transactions at values below $5. The fee structure for the SWIFT network is not attractive for such low value transactions. An error in coding the message or inaccurate destination information, especially when the destination is not a member institution of the SWIFT network, will cause the transfer to fail. Further, the messages literally have to be coded according to a very specific and rigid format and any deviation can lead to an error. As a result, banks and other payors may experience a 1-2 percent error rate in transfers, which may result in hundreds or even thousands of employees being dedicated to following up on missed payments and to taking corrective actions at a cost of millions of dollars, not to mention the business impacts of missed payments and poor customer relations.

Finally, due to limitations in both the financial networks and legacy payment architectures, the full value of receivables and payables in one country may each be transmitted to a home country and currency for final accounting, even though the net difference of the receivables and payables may be small. As a result, even more transfers are created which increases the incidence of errors, which, in turn, will have to be corrected. Exception handling in low value transactions makes the related expense even more costly and burdensome for both banks as service providers and the corporate clients directing the payments.

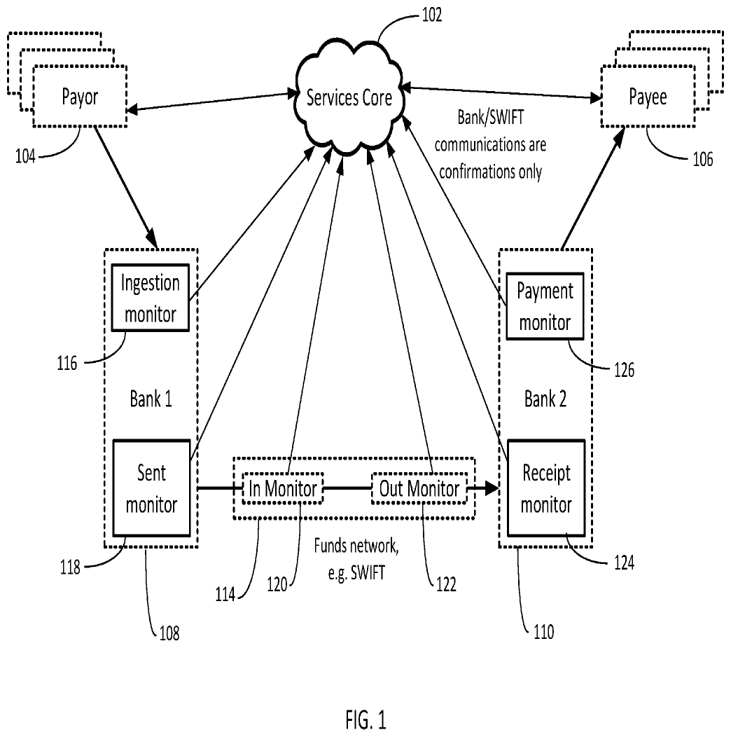

FIG. 1 illustrates an embodiment of elements supporting an encrypted and authenticated message service that addresses the drawbacks of the SWIFT network while reducing the overall number of transactions requiring international funds transfers. A services core 102 may incorporate access to payor accounts and obligations while also providing payees a way to self-maintain accounts and set preferences for payouts. The services core 102 may also match obligations and receivables, including a predictive service for anticipating future needs, that allows net settlement of accounts in-country before initiating international transfers of funds with a home country and currency. The net settlement may occur (i) inside the services core 102 itself, (ii) between the services core 102 and corporate client's ERP and other treasury management systems' services cores, or (iii) amongst the services core 102, and multiple corporate clients' systems, which would allow the primary services core 102 to act as an exchange between two corporate actors' service cores. The services core 102 may further evaluate alternate funding sources available in-country, such as a non-bank currency source including mobile network operators and private equity resources. This flexibility of services allows a hierarchy of routing so that the lowest cost source can be selected. For example, an in-country transfer may be evaluated and selected, when available, if such routing has a lower net cost than an international transfer.

The services core 102 may be coupled to both a payor 104 and a payee 106, each of which may represent a plurality of payors and payees. A first bank 108 and a second bank 110 represent any number of financial institutions that may routinely participate in funds transfers between the payor 104 and the payee 106. In various embodiments, there may be no restriction on direct of funds transfers. That is, in one transaction payor entity 104 may provide funds, while in another transaction, the payor entity 104 may receive funds. For the sake of simplicity of illustration, the following description uses the payor entity 104 as the source of funds but in practice the system is symmetrical as to roles, A communications network 114 may support messages containing instructions for financial transfers, or may use a proprietary communication protocol, or merely proprietary security protocol (e.g., keys) on a non-proprietary communication network. In an embodiment, the communications network 114 may be the SWIFT network or any other standards-based payment or messaging network, but in other embodiments, the communications network 114 may be any public or private entity that acts in this capacity.

FIG. 1 also illustrates a sample flow of instructions related to a payment or other funds transfer. The flow follows from the payor 104, to the first bank 108, through the communications network 114, to the second bank 110, and ultimately to the payee 106. Funds flow and messaging is omni-directional. Actual funds may be transferred between adjacent entities except that the communications network 114 generally does not hold any accounts or perform any payment or settlement.

An aspect of the ability of the services core 102 to perform its various roles is collection of data at various points in the transfer process through the use of sensors or monitors. The first bank 108 may have monitors where data is received and where data exits [NOTE: see comments above, we will put sensors everywhere, so in our engine,]. These may be, respectively, an ingestion monitor 116 and a sent monitor 118. Similarly, the communication network 114 may have an in monitor 120 and an out monitor 122. Finally, the second bank 110 may have a receipt monitor 124 and a payment monitor 126. These monitors, and those discussed below are merely representative of monitors which may be placed at every transfer and activity point in all participating system elements. For example, every step in the process may include monitoring, which extends to all systems that interoperate with the services core 102. These monitors may provide, constant, rich data based on business rules that are configurable for workflow changes per the needs of each client. In each instantiation, the monitoring may change with the workflow. For example, all RESTful APIs at each communication point may include monitoring. In another example, one or more monitors may provide data for acknowledgements and reconciliation.

Each network or communication function may include monitors as needed, including private networks, virtual private networks. In the case of the SWIFT network, the in and out monitors 120, 122 may be present in a current release of that system and require no development on the part of the SWIFT network although the bank 108 may be required to request the data provided by the in and out monitors 120, 122, via a programmatic interface. In the following description, certain monitors and their associated functions are disclosed. These monitors are shown for the purpose of illustration and in different embodiments there may be more or fewer monitors in each of the entities in the transaction flow, each providing a window into the state of the transaction at the point of the monitor. In an embodiment, each processing function in the transaction flow may include a monitor or sensor that reports back to the services core 102 as much data as may be relevant. This may include completion of the function but may also include other data such as initiation or intermediate processing steps. RESTful API's may expose as much or a little data as determined by system architects or designers. Some or all of this data may then be reported to the payor 104 and the payee 106, as desired or appropriate. While the monitors may be useful in reporting status and highlighting possible errors, the monitors may also be used for real time confirmations at each step so that acknowledgments and reconciliations may be performed on an automated basis so that the system is constantly up-to-date on any particular transaction. In this manner, the highly asynchronous prior art systems may be driven toward a more synchronous behavior allowing reconciliations in near real time.

Banks and other financial institutions are highly regulated and changes to data flow and routine processes may be difficult to implement. The networks used for transaction processing may include public and private networks using encrypted or clear channels. The networks may be owned and operated by individual banks or may be non-bank commercial networks. In some embodiments, mobile network operators (MNOs) may provide network connectivity or may participate in transaction monitoring and processing. For this reason, various monitors may sit above the actual financial processing flow. For example, while a payment message received at the first bank 108 may arrive from the payor 104 via a known channel such as a secure extranet or virtual private network (VPN), the monitors 116-126 may not use or have access to these secure channels. APIs are available for all functions that include monitoring, and therefore even if a monitor cannot be included inside the function, the services core 102 can monitor the errors created during a function, or successful processing of such function, such that the next function begins.

Of note is that, in an embodiment, each of the monitors illustrated only reports out confirmation data to the services core 102 and the content of messages are status only. Transactions may be referred to, in some cases, only by a transaction identifier so that minimal information is delivered, reducing the ability for an unwanted actor to glean information even if a status message is compromised. Because the monitoring messages are status only and outbound only, the banks 108, 110 may not need to take extraordinary data security precautions that might arise if inbound messages were being processed. For example, bank firewalls (not depicted) may only allow outbound traffic (other than low-level confirmation protocol-related incoming data). However, such a minimal amount of data may also have a minimal amount of error checking data and errors, which commonly would be caught may flow through a system. For example, if a payee name AND account number were included in a message, the account number may be promptly checked against the payee name and a mis-match may be caught virtually immediately.

The status or confirmation messages may be formatted in compliance with an agreed upon application program interface (API) that facilitates easy setup, debugging, and operation. Funds transfers between banks 108, 110 may be symmetric and have equivalent monitors in either direction, however, for the sake of simplicity for this disclosure, only one direction of flow and those associated monitors are shown.

The elements depicted may be intended to function with no to minimal changes to the current flow of a transfer used in a prior deployment. That is, a payor 104 may have an enterprise resource planning function, treasury management software or similar application that determines what obligations are due each recipient or payee. That information may be forwarded to an operation of the payor's treasury department where a flat file of payment information is assembled. The flat file, or simple ASCII text, may have one row per payment, with each row designating a payee, any required regulatory explanations, a source account, a destination account, and an amount, with variations by payor company, bank, and method. The flat file may be sent to the payor's bank 108. The bank 108 may process the flat file and, when required, may generate SWIFT messages with similar information as above. Next, the SWIFT message may be received by the recipient bank 110. The recipient bank 110, presumably holding an account for the payee 106, may make a deposit to the recipient account, and ultimately settlement with the payor's bank 108 may be made. In an embodiment, the payment instruction from payor 104 will go to the services core 102 and be ingested, resulting in instructions occurring in this exemplary order: 1) confirm payee preferences in services core 102; 2) Net settle across portfolios to have disbursement funds in each local market; 3) Where net settlement lacks sufficient funds, use currency exchange or float to deliver local funds, replacing multiple SWIFT transactions with a bulk funds transfer; 4) Once in-country, deliver funds to bank accounts, e-wallets, cards, cash. 5) Generate real-time alerts for key steps for payor 104 (e.g., into SAP) & payees 106 throughout workflow. In this embodiment, steps 3 and 4 may use traditional bank messaging.

In such an environment, once the first flat file is delivered to the bank 108, today there may be no further confirmation messages fed back to the payor 104 or the bank 108 until an actual settlement is completed. If any upstream participant wants to confirm receipt by a downstream participant, or if settlement fails to occur in an expected timeframe, the upstream participant generally makes a phone call to the other party to get a verbal confirmation. When such confirmation involved in tracking and correcting lost transactions is in a range of 1-2 percent of dozens or even hundreds of payments, the associated overhead may be an acceptable cost of business. However, this manual process of verification, tracking and correction does not scale well. When millions of payments of both large and small value transfers are being made, the cost of manual follow up on a 1-2 percent error rate may become unacceptable high. The monitors contribute to scaling to higher volumes and help diagnose a point in the transaction routing where an error occurred or at least was first identified.

The ingestion monitor 116 may support unidirectional messaging with the services core 102, with the understanding that any communication protocol requires at least some level of two-way signaling associated with sending even a unidirectional message. The ingestion monitor 116, like the other monitors, may be in the form of an application program interface (API) using, for example, a RESTful interface, that collects data from a specific point in the transfer sequence. The bank 108 may simply use the API to extract the needed data and forward it to the services core 102. The ingestion monitor 116 may collect data from an incoming data buffer or database in one embodiment. As discussed above, the ingestion monitor 116 may also participate in acknowledgments used for automated reconciliation of transactions and accounts.

In another embodiment, the data may be collected after the flat file has been processed by the bank 108 prior to forwarding to the next entity. In one embodiment, only a transaction ID may be sent, minimizing personally identifiable data from being transmitted. However, in another embodiment, the API may be used to extract all possible details related to the transaction so that more detailed error detection may be performed at services core 102. The RESTful API allows for payor 104 to send the services core 102 payment instructions dynamically, and the services core 102 will disaggregate each element of the payment instruction in order to respond to each element of payee instructions, and pass funds flow through lowest cost routing.

When an error is detected, a message may be generated and sent to the bank 108, indicating the error. The bank 108 may be motivated to provide monitor data as a way of reducing its own cost of doing business as relates to identification of errors, even those errors that occur outside the bank 108 but for which the bank 108 must expend resources to eliminate itself as the source. Because the bank 108 is only providing data, its compliance obligations related to data security may be minimized compared to receipt of external files from a third party.

As implied by the name, the sent monitor 118 may transmit a confirmation when the transaction data leaves the bank 108 and is sent to the communications network 114. As above, the communication may be minimal or may expansive. When the communications network 114 is the SWIFT network, existing monitors 120, 122 may be used to confirm entry and exit of data from the network 114. In other communications networks, the monitors 120, 122 may also be implemented using the same or a similar API as used in the bank, performing essentially the same functions of reporting status, with or without complete transaction details. As discussed above, there are almost no limits to the variety of networks, owners, encryption schemes, etc., in use and the configuration of the monitors or relevant API's provides a flexible approach to accommodating these variations.

Similarly, the second bank 110 or an additional receive provider like PayPal or Alipay, or cash out service provider like Western Union, or multiple trading desks globally across a single bank may have monitors placed at points within the its internal transaction process. The receipt monitor 124 may confirm transaction details as received or as processed after receipt, or both. The payment monitor 126 may report the completion of the payment to the end payee 106.

In some cases, the transaction may not be directed strictly a currency value but may be a security including, but not limited to, a cryptographic key, a digital currency, or an escrowed value. The monitoring and confirmation process may be similar, if not the same, for any of these alternate securities. In such cases, the recipient/destination may be a third party repository, rather than a bank or other financial institution. In such cases, the transfer may not be simply a fungible asset, such as currency, but a change of ownership. The object of the transfer may be virtual, such as a crypto-currency, or may be a tangible asset such as real estate.

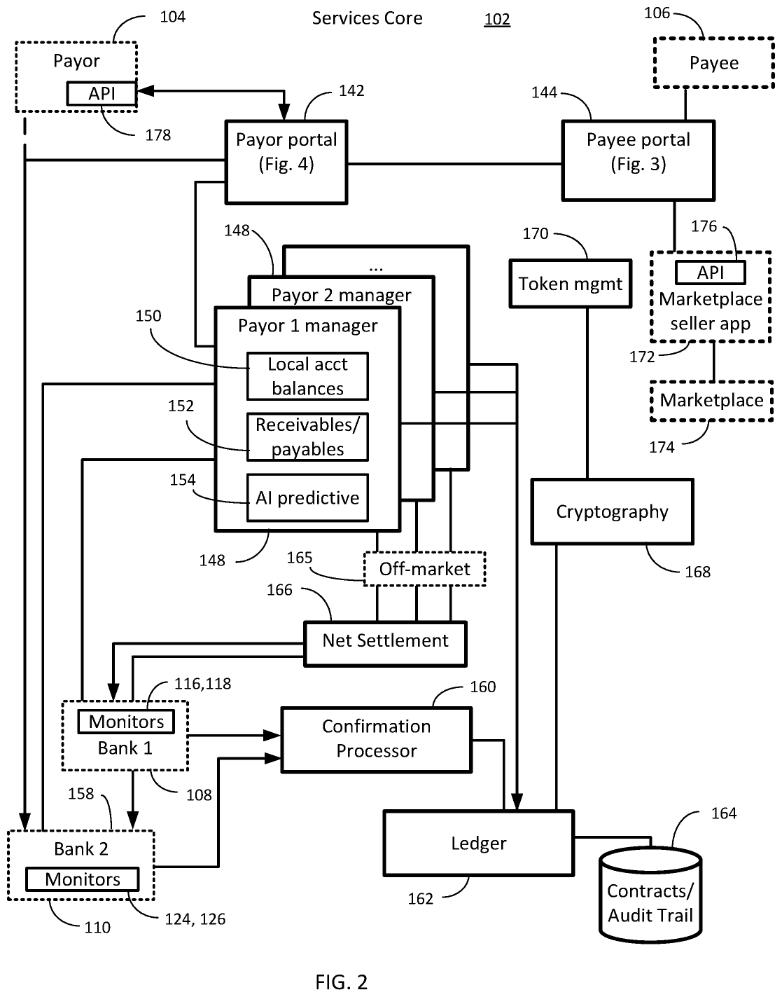

Turning to FIG. 2, the services core 102 is discussed and described. The services core 102 may have several independent but interrelated functions. In an embodiment, the services core 102 may be implemented on a single server using multiple connections and interfaces to outside entities. However, in another embodiment, particularly when operating at scales of millions of transactions, the functions may be physically implemented on different servers in a distributed fashion where the various servers are purpose built to execute a function or plurality of functions. In some embodiments, the implementation may be a hybrid of the foregoing embodiments such that for certain jurisdictions, service core will be instantiated in one or more local servers and its transaction processing and related data storage will be territorially bound; the remaining jurisdictions will rely on an array of distributed servers with deliver a very high throughput and service level with highly efficient hardware footprint. Even single functions may be distributed across different servers and different geographies to reduce latency and increase both system availability and system capacity. The techniques disclosed are not reliant on any particular hardware architecture but specific, purpose built hardware may create additional speed, accuracy and efficiencies. For example, a server may have a large input output circuit if data flow into or out of the server is expected to be high.

A payor portal 142 may be logically connected to a payor 104. In an embodiment, there may be an instance of the payor portal 142 for each payor 104. However, in an embodiment, the payor portal 142 may be embodied as a suite of APIs that present the functionality of the front-end user interface and data preparation but that interact with an existing ERP or treasury management system.

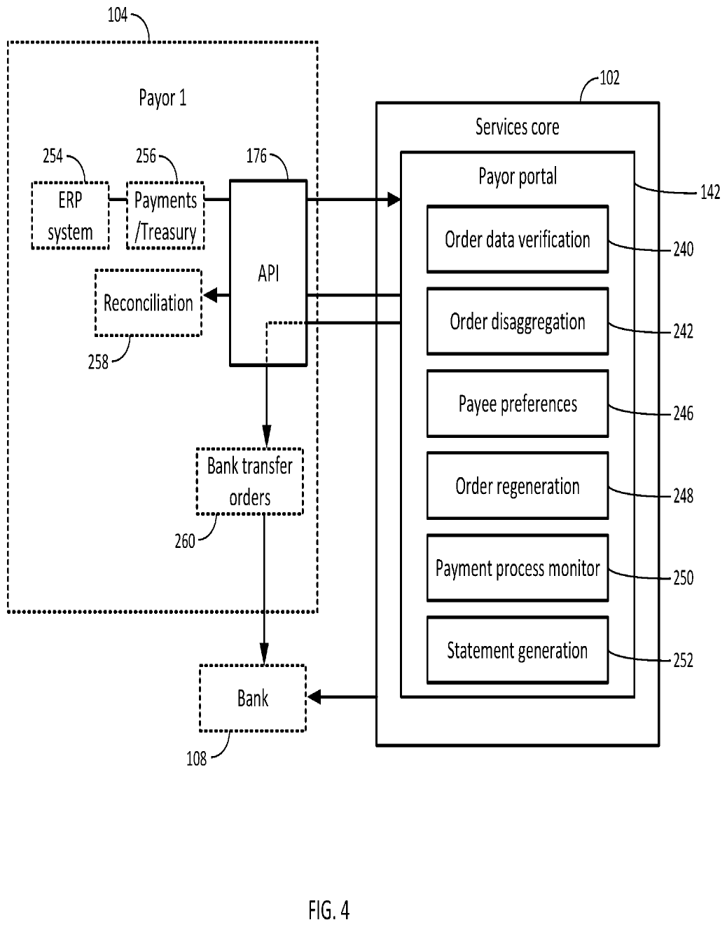

Different embodiments of the payor portal 142 may handle multiple payors using different processing constructs. The payor portal 142 is discussed in more detail below with respect to FIG. 4. Briefly, the payor portal 142 may be responsible for receiving payment orders from the payor 104, matching individual orders to payee preferences, and re-assembling payment instructions that reflect the payees wishes, including separating a single payment obligation into multiple payments that may include different payment vehicles, destinations, and currencies.

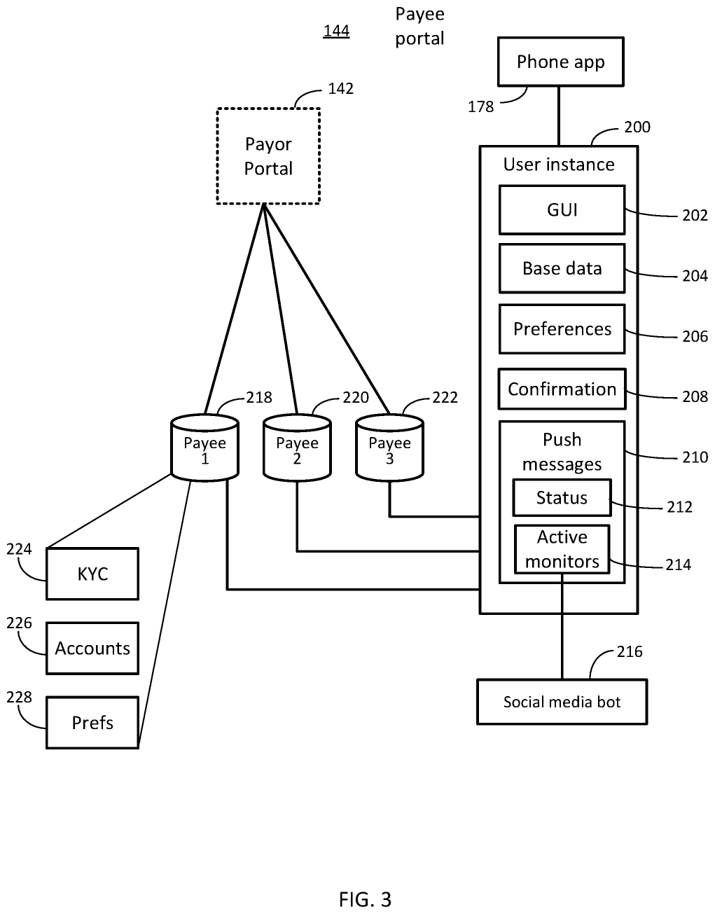

The services core 102 may also include a payee portal 144 that supports communication with a payee 106. As above, the payee portal 144 may be implemented with different architectures that support the functions described. Similar to the payor portal 142 as described above, the payee portal 144 may include a suite of APIs that present a front-end interface and couple to payee systems as available and services core functions relevant to one or more transactions. For example, one instance of the payee portal 144 may be created for each payee 106. The payee portal 144 is discussed in more detail below with respect to FIG. 3 below. In brief, the payee portal 144 may allow the user to enter preferences about bank accounts, payment instructions, and contact details. The payee portal 144 may also support social media monitors, phone applications, and databases for use by the payor portal 142 and other functions of the services core 102 itself.

The services core 102 may include one or more instances of a payor manager 148. The payor manager 148 may receive data from the payor portal 142 and, optionally, data directly from the payee portal 144. The payor manager 148 may also receive data from the banks 108, 110 related to payor account balances, among other data. The payor manager 148 may also report out data to a net settlement manager 166 and a ledger 162, both discussed more below. As discussed above, the payee portal 144 for a single payee may support data access for any number of payors.

The payor manager 148 may include local account balances for some or all of the payor's bank accounts at various banks and even in different countries. In an embodiment, the payor manager 148 may be given access credentials that allows the services core 102 to query the accounts for at least current balances, if not more, such as pending debits and credits. The ability to know one or more payor's account balances is one facet of being able to perform a net settlement function either between the payor's own accounts and obligations, as well as between multiple payors. In an embodiment, the different payors 148 may be business units of the same company or may be separate companies. In an embodiment, the payor bank accounts, from a settlement and monitoring standpoint, will sit in parity with services core accounts for global coverage for settlement, and for access to e-wallets, cash out and card loads. In yet another embodiment, the transferred funds may be made to a directed account. That is, funds may reside in an institutional virtual account awaiting further instructions before being transferred into a final fiat currency or another non-first form of value.

The payor manager 148 may also keep track of the payor's receivables and payables at a receivables/payables module 152 using data received from the payor 104. The payor API 178 may provide access to this and other related data, as discussed more below. In an embodiment, the system may interoperable with value-added applications used in support of the system. For example, applications related to the transfer of funds may include value-at-risk calculations, balance tests, trade finance or other liquidity solutions, as well as other incremental business applications. The module 152 may be updated in real time either on a pull or polling basis or on a push basis depending on the implementation. In another embodiment, the receivables/payables module 152 may be updated daily, for example, at a predetermined time when books are closed. Having a knowledge of assets and liabilities allows net settlement between internal accounts and with external partners to reduce the volume and velocity of funds transfers, particularly foreign currency transfers.

An artificial intelligence (Al) module 154 may use machine learning and other heuristics to predict optimal values for net settlement transfers. As background, companies, particularly international companies, have financial obligations at many levels and may make multiple foreign currency transfers throughout a 24 hour period. Some transfers may be to pay vendors. Other transfers may involve receipts from customers. Other transfers may be between company accounts to take advantage of spot rates on currencies in foreign countries or to balance accounts at the end of a fiscal period. Other transfers may be between internal divisions to account for goods or services performed by one group for another group. It is not uncommon for a large multi-national company to transfer billions of dollars a day amongst accounts at various international bank accounts or accounts with other financial institutions. Each entity within a company could be responsible for making these transfers. However, many companies may have a treasury department that handles such transfers in order to achieve economies of scale and to ensure regulatory compliance.

For example, a company with multiple divisions in the U.S. and Australia may group transfers together between one of its U.S. bank accounts and another of its Australia bank accounts so that a single transfer from the U.S. to Australia can cover multiple individual transactions and thereby reduce the transfer fees and currency exchange fees. However, even this grouping of transfers may only cover transfers accumulated within a single operating unit or between specific end-point banks. As mentioned above, these prior art techniques for managing transfers may not scale well to millions of small transactions over a few days or even a few hours. The prospect of the Internet of Things increasing the volume of those transactions to include autonomous purchases made by smartphones, household appliances, automobiles, and more, places an burden on treasury departments that was unimaginable even a decade ago.

Returning to the Al module 154, Al and machine learning may be used to analyze data from a multitude of sources including sales, shipping, inventory, accounting and others to develop models of expected currency needs by region, by country, and even by individual accounts, seasonally adjusted. These models may be highly integrated so that international transfers are minimized and in-country transfers between suppliers, customers, and service providers are maximized. In one simple embodiment, funds received by sales of music via a company's (payor's) Internet store in one country may be used to pay royalties to artists in that country. However, a more complex scenario may involve using funds from the sale of music in one country to pay a supplier of plastics for the company's auto parts manufacturing division in that same country, while caching all reporting that tax authorities require for each respective company business lines. At the end of the day, or other reporting period, if music sales exceed the cost of goods, a net transfer of profit may be sent to a U.S. account. In another scenario, MNO technology may be used to provide lower cost routing for net settlement of acquired funds or may use of a third party in a more favorable currency to that present in a default workflow.

Expanding beyond the music examples, the total income of all operating units may be considered against the total liabilities of all units in order to reconcile larger numbers of potential foreign transactions into a single transaction perhaps performed daily. Beyond that, company “A” may experience an excess of local currency in one country while company “B” may have a short term need for local currency. Given this knowledge, a currency swap may be transacted to cover the needed position at a favorable terms for both parties compared to holding the currencies or exchanging funds with bank service providers and incur fees. The Al module 154 may be a three tier ML construct that uses and input layer to receive input data and an output layer that provides optimized transfer amounts. A weighting layer between the input and output layers may allow the system to be trained to provide more advantageous results as different scenarios are comprehended over time.

The Al module 154 also may be used to learn from past transfers to determine if pending transactions are suspect. For example, the Al module may determine Entity A may create transfers between 4 μm and 5 μm Monday through Friday. If a transfer is sent by Entity A on a Saturday morning, the transfer may be noted as possibly having an error or being fraudulent. The Al module 154 may also be used to determine throughput needs for all payors globally, and provide information related to service levels, capacity demands and other pressures on the operation of the service core.

In an embodiment, an off-market currency marketplace 165 may optionally be added to the system to provide near-real time liquidity when markets are closed.

The net settlement module 166 may respond to instructions from the Al module 154 and generate instructions for executing the transactions required to minimize foreign exchange fees and international transaction fees. For example, the net settlement module 166 may generate bank transfer instructions between multiple in-country banks and between banks in foreign jurisdictions. The net settlement module 166 may include rules for generating transfer instructions as well as regulatory compliance information that may be used to ensure that transactions do not violate local and regional regulations for transfers. In another embodiment, some or all of the functions of the Al module 154 may be incorporated into the net settlement module 166; particularly to the extent that funds that would historically be sent internationally to reporting/retained earnings/profit accounts as excess currency, could be retained in-country and readied for a forthcoming net settlement, removing both the immediate foreign exchange costs and the forthcoming currency deficiency in a given country. This may particularly be the case when the services core 102 prepares and executes transfers between payors 148.

A confirmation processor 160 may receive data from, among other elements, monitors placed in the transaction flow path, for example, monitors 116, 118 at the first bank 108 and monitors 124, 126 at the second bank 110. The confirmation processor 160 may have data from the payor portal 142 or payor manager 148 about in-process or expected transfers so that reported events can be matched to anticipated events. When available, this matching between expected and actual events may provide for identification of error points and reduce the lag time between when an error occurs and when the error is recognized. This data may be made available to payors in order to improve operations. For example, an embodiment may include publishing such data in raw form to a payor's payment operations and treasury, and highly customized aggregate form for finance, product, and other operations.

As transactions are authorized and executed, the associated events may be captured in a ledger 162. In an embodiment, the ledger 162 may be a secure, verifiable audit trail using a blockchain technology. The ledger may use a private, or permissioned, blockchain technique to capture an immutable copy of transaction history. As is known, private blockchain uses one or more trusted parties to sign transactions so as to the avoid the time delay and energy required by the proof of work function of a public blockchain. The details of a transaction recorded in a ledger may have varying levels of access according to role. For example, so that end parties may be able to see all details, banks may see fewer details, and regulators may see the least detail, but all may see the data needed for them to perform their roles. In various embodiments, the hierarchical access to data may extend through different layers of business partners including sub-payees of higher level payees and payors with various levels of management access within the organization. The ledger data may be stored in a database 164 for security, redundancy, and recoverability reasons.

Associated with both the private blockchain and tokenization, discussed below, may be a cryptographic function 168. The cryptographic function 168 may store cryptographic keys, both symmetric keys and asymmetric keys, and may include functions for random number generation, key generation, signing, verification, encryption, and decryption. The cryptographic function may also manage key updates and key rolling as needed, as well as generation of various levels of derived keys from master keys.

A token manager 170 may perform the process of substituting sensitive data for a non-sensitive equivalent. In some cases, tokenization may involve substitution of a primary account number (PAN) with a token equivalent so that while in transit on a public network only the token is susceptible to compromise. However, the real PAN may be substituted back into a transaction after verification of security compliance so that fraudulent transactions are reduced. In other embodiments, the token may simply be a random number generated from computation algorithms using, for example, elliptical curve encryption, and assigned to as an account identifier and when the transaction is processed, the real account information is re-introduced. A private blockchain is an embodiment of such computational key generation, which would be published to multiple trusted authoritative parties. This process allows less secure participants to generate information associated with, for example, a tokenized account number and then have the real account information added at the services core 102 or a bank 108. Tokenization may be most applicable at public data access points such as the payee portal 144, but may also be useful at other touchpoints such as the payor portal 142.

In some embodiments, the payee portal 144 may interact with an API 176 that may be placed in a third party application. For example, in the illustration of FIG. 2, the API 176 may operate within a marketplace application 172 running on a cellular device and coupled to the marketplace 174. Because the marketplace 174 may be a source of revenue for a payee, the API 176 may let the payee interact with the payee portal 144 as an integrated part of the payee's normal monitoring of his or her business. That is, the payee may use the application 172 to request a payout from the marketplace 174 and may further use the API 176 to confirm and select accounts, currencies, or cash vehicles such as prepaid cards or cryptocurrencies for receiving the payout. The API may provide specific calls from within the application 172 for adding/deleting accounts, confirming personal details, selecting accounts and indicating payout splits for specific transactions. The API 176 may support viewing progress of the transaction, particularly if the marketplace 174 is a participant in the system as a payor 104.

One example of a payee portal 144 may be illustrated in block form in FIG. 3. The payee portal 144 manages interactions with a user or payee 106 who may be owed funds from one or more payor 104. The payee portal 144 may be coupled to a payor portal 142, or in one of several possible alternate embodiments to a corresponding instance of a payor manager 148. One function of the payee portal's interface with a payee 106 may be to confirm account details and to receive payment preferences for a specific payout or as a general setting for all payouts to that payee 106. A user instance 200 may provide support for communication with the payee 106. The user instance 200 may include various modules that support specific functions.

The illustrated embodiment is but one example of several alternative schemes for addressing these functions. A graphical user interface (GUI) module may determine characteristics of a platform at which the user is working and may generate formatted data according to those characteristics for use in generating a user interface screen. For example, an application running on a smartphone may have different constructs than a browser operating on a desktop or laptop device. Further, the GUI may be designed to minimize errors which are all too common, highlight possible errors before they occur, note opportunities, make suggestions to reduce transactions, etc.

A base data module 204 may collect and store information about a user's accounts, contact information, location and regulatory jurisdiction, etc. This and other data about the user/payee may be stored in a database 218, database instance, or data record. Preferences may be collected via a corresponding module 206 or through a user interface designed for such a purpose. The separation between base data and preferences may serve to illustrate that preferences, in particular payout preferences, may change more frequently than the base data and therefore may have a different user interface that provides a simplified interface for directing funds to different accounts or payment formats, e.g. bank account vs. prepaid card.

A confirmation module 208 may collect notifications sent by a payor 104 that a payment is pending and then match those notifications to account statements/balances as one or more related payments are received. That is, as discussed above, a payee 106 may have received a payment notice from a payor 104 and determined that 30% is to go to a first U.S. bank account, 20% to a first Australia bank account, and 50% paid in Euros to a prepaid card in France. The confirmation module 208 may audit the selected bank transactions and watch for the related prepaid card transaction in order to confirm and close the payment. Another aspect of the confirmation module 208 may be to raise an alarm when an expected payment is not confirmed within a particular time frame. In an additional embodiment, the confirmation module 208 may attempt to correct errors related to problem confirmations before raising an alarm.

A push messages function 210 may allow the services core 102 to proactively send information to a payee 106 at one device or multiple devices as designated by the payee 106. The messages may use one or a combination of known message transports including, but not limited to, text messages, email notifications, voicemail, or alerts received via a phone application 172. The push messages may include status updates received, for example, from the confirmation module 208 and formatted/generated by the status module 212.

In some embodiments, an active monitor module 214 may receive data from one or more sources. One such source may be a social media bot 216. The social media bot 216 may routinely check various social media sources associated with the payee 106 such as Facebook, Twitter, LinkedIn, etc. These sources may indicate when a change in the user status has occurred that may affect the user's base data, or even his or her preferences. One of the largest sources of errors in transfers may be when the user information changes but is not updated, such as account details. The social media bot 216 may be able to glean information about a payee 106 such as address changes, marital status changes, etc. that could affect the accuracy of his or her personal or account data. The active monitor 214 may receive such information and send a message to the payee 106 suggesting that personal and payment information may need to be updated. In addition, the active monitor 214 may verify that data remains accurate.

Payee information may be stored in one or more databases 218, 220, 222 or similar repositories, either at an onsite facility, in the cloud, or a combination of both. The information may be stored for a payee 106 may include elements of interest to both payors, financial institutions, and even regulators. As with ledger data above, this information may be available in a tiered fashion so that all the data may only be available to select parties while portions of the personal information may be restricted from other entities accessing the data. The user data may include, but is not limited to, know your customer (KYC) data 224, account information 226, and preferences 228. KYC data 224 may be information that a payor 104 can rely on for proof of identity in order to reduce fraud and money laundering by account holders or their representatives. Account data 226 may include details such as bank routing or IBAN numbers, bank account details, personal and business location information, etc.

As discussed above, preference data 228 may include transient or standing orders related to payouts. These may include country/currency preferences, bank preferences, third party payments, cash or prepaid payouts, and others. Payee portal 144 may show default/present payee payment instructions, additional options available to the payee at all times, and any costs burdened upon the payee associated with the use any such payment type, currency, etc. The preferences may be in place for a single transaction, over a period of time, or left as standing orders until changed, a so-called default setting. Particularly in the last case, indicators as to the current applicability of such standing orders may be checked in the hope of avoiding sending funds to an account that is closed or to an address where a payee 106 no longer resides. By proactively searching out such changes, costly and time-consuming delivery errors may be avoided.

The payor portal 142 may have access to some or all of the payee database 218, 220, 222 so that payment data received at the payor portal 142 may be processed in accordance with the payee's wishes. The processing rules may be set by a user using a user interface to ease the process and minimize errors. FIG. 4 is a block diagram illustrating an embodiment of the payor portal 142. As with the payee portal 144, the payor portal 142 may be logically implemented within the services core 102. As discussed however, the physical and logical architecture of the services core 102 and the payor portal 142 may vary by implementation. The payor portal 142 may include various modules that operate on information received from the payor 104.

An order data verification module 240 may receive order information from the payor 104 and may check for data consistency as well as data accuracy. In many cases, the order data is received in a legacy format flat ASCII file via an original request generated by a corporate enterprise resource planner (ERP) 254 and executed by a payments group of a treasury department 256. In an embodiment, this flat file may be exactly the same file that in a prior art implementation would have been passed to its bank 108. Row and column-oriented data may use a conventional format, such as comma-separated values (CSV), so that the order data verification module 240 may parse the incoming data and match it to a known template. If an error in transmission occurs, some expected data may be missing or a particular field may be out of range. After identification, some of these errors may be recoverable through coding techniques, but other errors may require re-transmission by the payor 104. In another example, the data may meet formatting rules but may contain information that is not accurate. For example, an IBAN number may not match any known entity. These errors may also be managed as the situation dictates.

An order disaggregation module 242 may take the flat file, that is, the row and column data of the order file and separate it into discrete lines, in an embodiment, by payee 106. While the payor 104 may only know that the payee 106 is due a certain amount of funds, it may only have only one destination account for the payee 106. In some cases, the payor 104 may only be capable of implementing one destination account for a payee 106 due to legacy system restrictions. In other cases, the payor 104 may simply not want to be bothered with the overhead associated with allowing payees to make splits to payouts as well as other payout instructions and account data that can change as often as each payout. The payee preferences module 246 may take each line item of the payment in the order data and match it to payee accounts 226 and preferences 228. The payee preferences module 246 may also match the payee 106 to KYC information 224 and verify compliance of the data to the jurisdictions in which payments are to be made. The payee preferences module 246 may have a user interface which may allow splits and routing plans to be created and tested.

After completion of transactions, the service core's reporting and auditing capabilities may match disaggregated payment instructions to invoices, if the payor 104 desires or requires such functionality. This capability adds a new computational step at the end of payment acknowledgement, which may lower the computing power needed in ERP reconciliation, as every payment event is wrapped in rich semantic data such as acknowledgement and intention of the payee.

The payee preferences module 246 may create new order data based on the payee's instructions, as illustrated by the sequence below.

TABLE 1

| Payee | IBAN | Account | Value | Currency |
|---|---|---|---|---|
| John Doe | 2345654 | 789089 | $120.00 | USD |

Table 1 may illustrate a row of payee data that has been disaggregated from the order file, which the processing engine in the services core 102 may further disaggregate by payee, country of bank account, and currency. Table 2 may illustrate the payee's preferences that are applicable to the current payment, either explicitly or as a standing order. These preferences may be maintained, verified, and updated by the payee 106 via the payee portal 144 as discussed above.

TABLE 2

| IBAN | Account | Split | Currency | Address |
|---|---|---|---|---|
| 222111 | 999888 | 50% | USD | |
| 444556 | 877766 | 25% | AUD | |
| Prepaid | France | 25% | EUR | Primary |

Additionally, the payee is not obligated to exhaust all funds due when confirming payment instructions. The services core 102 may hold non-directed funds in a virtual state until such funds are directed.

Table 3 may illustrate a regenerated order file with the updated payee line items replacing the original single row order information received from the payor 104.

TABLE 3

| Payee | IBAN | Account | Value | Currency |
|---|---|---|---|---|
| John Doe | 222111 | 999888 | $60.00 | USD |
| John Doe | 444556 | 877766 | $30.00 | AUD |
| John Doe | Visa prepaid | | $30.00 | EUR |
| c/o 7/11 | | | | |

When building the regenerated order file, the order regeneration module 248 may take the individual payment requirements for each payee and generate a new order file that reflects the payee preferences. That is, the single payment amount designated by the payor 104 may be split to reflect one or more different accounts in different countries and currencies or full or partial payments to be made via stored value cards or other financial instruments. While the data illustrated is simplified and in readable text, the actual order file may conform to bank standards and conventions and may not appear in such a format. The regenerated order file may be sent directly to a bank 108, or in an embodiment, one or more other banks. In some cases, the bank 108 may only accept order files directly from the payor 104. In this case, the payor portal 142 may simple send the regenerated order file back to the payor 104 so that the regenerated order file can be received at the bank 108 from the payor 104 via an output interface 260.

A payment process monitor module 250 may receive data from the various monitors in the system or may receive data from the confirmation processor 160. The payment process monitor 250 may provide data to the payor 104 via the payor API 176. The status/confirmation data may be provided in several ways including a timed update such as daily, upon change, or upon a query. In different embodiments, one or more of these options may be supported in parallel.

The payment process monitor module 250 may also use artificial intelligence to learn from past transactions to identify possible errors. Further, the artificial intelligence may be supplemented by algorithms, which have been designed to identify errors. These errors may be communicated to a payor 104 or the payor 104 may select to have the transfer paused until it can be reviewed. As an example, a transfer 100 times greater than the payor 104 has ever made before may be identified as possibly missing a decimal point. In addition, the payment process monitor module may have a fraud detection aspect in that it may monitor transfers for possible fraud according to past transactions (using artificial intelligence) or fraud detection algorithms.

At any stage of a transaction, real time reporting is available so that completed transactions may be reported out and audited on demand. This allows statements to be generated as required or for statements to be eliminated entirely.

A technical effect of the system and methods described is an Al predictive module that generates order instructions based on predicted events in order to reduce overall funds flows between endpoints, particularly international endpoints. Another technical effect is the use of cryptographic ledgers (e.g., blockchain ledgers) to automate transaction verification while at the same time creating tiered access to data for end parties, financial institutions, and regulators.

The system and methods described benefit both payors and payees. Payees can have direct and real time control of their accounts, profiles, and preferences. Payees can direct individual payments to be distributed across multiple countries and accounts as well as across different payment instruments. Payors may benefit from dramatically reduced error rates in payments due to more accurate payee information and monitors that report activity as payments progress. Payors also benefit from net settlement of accounts in local currencies before international transfers must be invoked, thereby saving transaction fees and foreign exchange fees. The use of cryptographically secure ledgers benefits both payors, payees, financial institutions, and regulators as immutable and verifiable records of transactions are available to all interested parties.

We claim:

1. A system comprising:
a core that receives signals from a plurality of sensors in a plurality of networks supporting a data flow between a first party and one or more second parties;
a first portal that interfaces between the first party and the core; and
a second portal that interfaces between a recipient associated with the one or more second parties and the core;
wherein the first portal receives a value transfer message for use in the plurality of networks, and wherein the second portal provides a user interface for the recipient to specify conditions for the data flow.

2. The system of claim 1, wherein the core further comprises a manager that determines status of first party accounts and obligations in individual countries and exhausts in-country settlement options prior to performing an international transfer.

3. The system of claim 2, wherein exhausting in-country settlement options includes evaluating alternate funding options.

4. The system of claim 3, wherein evaluating alternate funding options includes non-bank third party currency sources.

5. The system of claim 1, wherein the core further supports a data storage system that maintains a cryptographically validated log of events related to activities supported by the core.

6. The system of claim 5, wherein the cryptographic validated log is a private blockchain.

7. The system of claim 1, wherein the core further supports an artificial intelligence engine.

8. The system of claim 1, wherein the first portal provides a second user interface for a second recipient to specify conditions for the data flow.

9. The system of claim 8, wherein the second portal interfaces between a second party and the core, the second portal receiving payment messages from the second party.

10. The system of claim 1, wherein the value transfer message corresponds to a currency-based transaction.

11. The system of claim 1, wherein the value transfer message corresponds to a transfer of a real asset.

12. The system of claim 1, wherein the value transfer message corresponds to transfer of a digital asset.

13. The system of claim 12, wherein the digital asset is one of a digital currency, an escrowed value, and a cryptographic key.

14. The system of claim 1, wherein the core further comprises a value added application.

15. The system of claim 14, wherein the value added application is one of a risk calculation and a balance test.

16. The system of claim 1, wherein the core further comprises an application program interface (API) installed on a user device, the API supporting a user interface that receives one or more options and causes the system to reprogram the second portal according to the one or more options received via the user interface.

17. A system comprising:
a processor and memory, the processor configured to execute instructions stored in the memory;
a network interface coupled to the processor, the network interface configured to send and receive messages with external entities;
a user interface coupled to the processor;
the processor implementing a database system that generates a compliant message for implementing a transfer responsive to instructions received via the user interface;
a module for compliant message content verification;
a module for compliant message disaggregation that generates disaggregated data; and
a module for message regeneration that generates one or more order files based on application of payee preferences to the disaggregated data.

18. A method of settling obligations in a country comprising:
receiving a payment obligation from a first source,
receiving a cash balance for the first source in at least one country;
calculating, at a processor, a first volume and velocity trend on the payment obligation;
calculating a second volume and velocity trend on the cash balance;
predicting a future cash position at the at least one country based on the first volume and velocity trend for obligations and the second volume and velocity trend for cash balances; and
transferring funds from an account in a first country to the at least one country based on the predicted future cash position.

19. The method of claim 18, wherein transferring funds from an account in the first country to the at least one country comprises transferring funds from a non-bank account in the first country to a bank account in the at least one country when the predicted future cash position shows a future shortage of cash at the first source.

20. The method of claim 18, wherein the first country and the at least one country are the same country.
